(19) United States
(12) Patent Application Publication
(10) Pub. No.: US 2009/0219683 A1
(43) Pub. Date: Sep. 3, 2009

(54) NOTEBOOK COMPUTER

(75) Inventors: Chihei Kitahara, Ome-shi (JP); Takahiro Nakazato, Tachikawa-shi (JP); Ko Nakazato, Tachikawa-shi (JP); Takeshi Iwata, Tachikawa-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: Kabushiki Kaisha Toshiba, Tokyo (JP)

(21) Appl. No.: 12/267,288

(22) Filed: Nov. 7, 2008

(30) Foreign Application Priority Data
Mar. 3, 2008 (JP) 2008-052451

(51) Int. Cl. G06F 1/16

(52) U.S. Cl. 361/679.55

(57) ABSTRACT

According to one embodiment, a notebook computer has, on the side surface of the device main body, a pin jack to receive a rod antenna. The rod antenna has a pin plug to be inserted in the pin jack and is rotatable when attached. The rod antenna is made of a flexibly bendable material. This prevents the rod antenna or its connection portion from being broken when a hand accidentally contacts it.

### CROSS-REFERENCE TO RELATED APPLICATIONS

This application is based upon and claims the benefit of priority from Japanese Patent Application No. 2008-052451, filed Mar. 3, 2008, the entire contents of which are incorporated herein by reference.

### BACKGROUND

1. Field

One embodiment of the present invention relates to a notebook computer having excellent portability.

2. Description of the Related Art

A personal computer disclosed in, e.g., Jpn. Pat. Appln. KOKAI Publication No. 2003-91342 includes an FM tuner and a DVD drive. This personal computer has a function of recording, e.g., audio data input from the FM tuner on a DVD.

To attach an FM antenna to the personal computer, for example, the antenna cable is stationarily led over the walls of a room.

Such a stationary antenna cable may accidentally be caught by an object so that it may be broken, or its connection portion may be damaged.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a perspective view showing the outer appearance of a notebook computer according to the embodiment of the present invention;

FIG. 2 is a perspective view showing the outer appearance of a rod antenna to be attached to the notebook computer shown in FIG. 1;

FIG. 3 is a schematic view showing a state in which the rod antenna is attached to a side surface of the notebook computer;

FIG. 4 is a schematic view showing a circuit board incorporated in the device main body of the notebook computer and a part of the rod antenna;

FIG. 5 is a view showing an example of an FM tuner operation window displayed via the display unit of the notebook computer; and

FIG. 6 is a flowchart for explaining a method of operating the operation window in FIG. 5.

### DETAILED DESCRIPTION

Various embodiments according to the invention will be described hereinafter with reference to the accompanying drawings. In general, according to one embodiment of the invention, a pin jack 2 to receive a rod antenna 1 is provided on a side surface 14b of a device main body 12 of a notebook computer 10. The rod antenna 1 has a pin plug 8 to be inserted in the pin jack 2 and is rotatable when attached to the device main body 12.

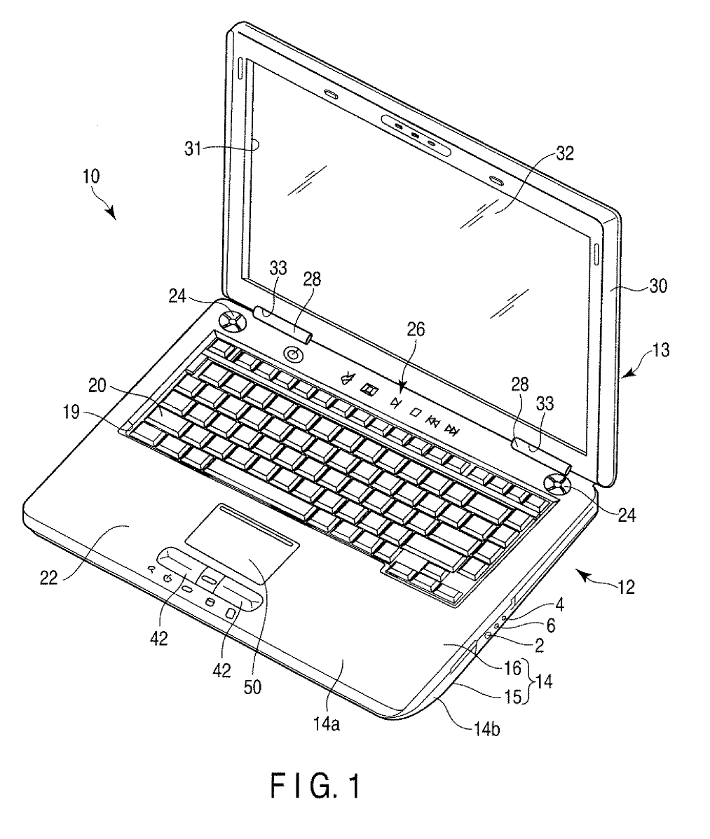

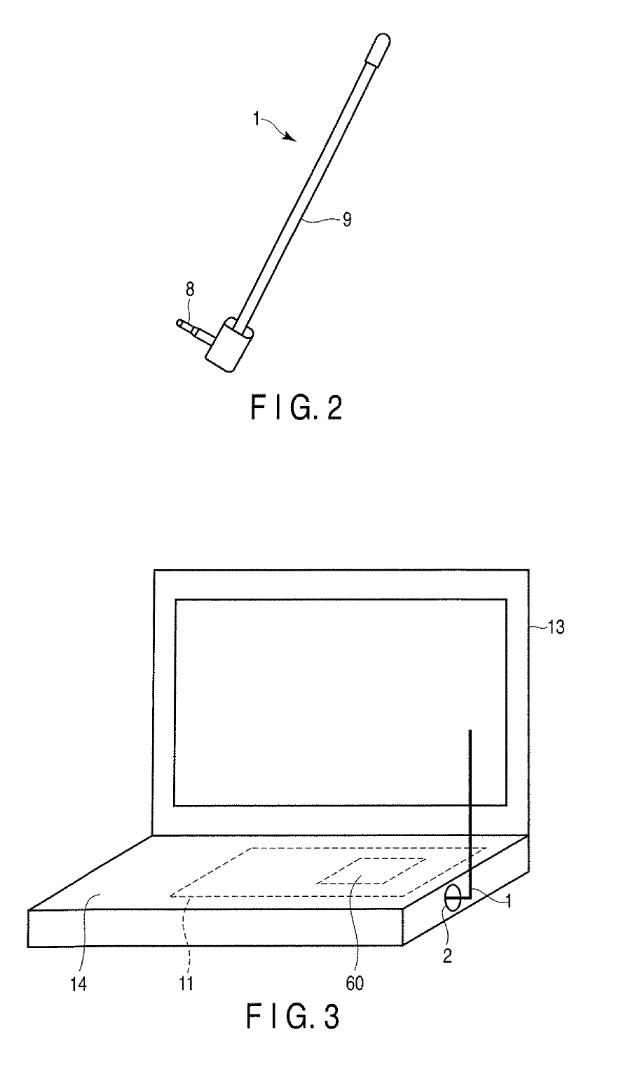

According to an embodiment, FIG. 1 shows the notebook computer 10. FIG. 2 shows the rod antenna 1 attachable to the side surface 14b of the notebook computer 10.

As shown in FIG. 1, the notebook computer 10 includes the device main body 12, and a display unit 13 (display panel) supported by the device main body 12. The device main body 12 has a case 14. The case 14 is formed into a flat box shape including an almost rectangular base 15 and an almost rectangular cover 16 fitted in the base. The external walls of the case 14 include an outer surface 14a and the side surfaces 14b, which are exposed externally.

The side surface 14b of the case 14 has the pin jack 2 to receive the rod antenna 1 shown in FIG. 2 as well as an earphone jack 4 and a microphone jack 6. The pin jack 2 has a diameter larger than that of the earphone jack 4 or microphone jack 6 to prevent the user from erroneously attaching the pin plug 8 of the rod antenna 1 to the earphone jack 4 or microphone jack 6.

In other words, the pin plug 8 of the rod antenna 1 also has a larger diameter to prevent the user from erroneously attaching it to the earphone jack 4 or microphone jack 6. In this embodiment, the diameter of the earphone jack 4 and the microphone jack 6 is 3.5 mm, whereas the diameter of the pin jack 2 is 4 mm.

The cover 16 has an almost rectangular opening 19 from the central portion toward the rear potion. A keyboard 20 is exposed in the opening 19. Almost the front half portion of the cover 16 forms a palm rest 22. The palm rest 22 has, at its center, an operation region 50 and click switches 42 to operate a pointing device. That is, the user places the palms on the palm rest 22 and operates the pointing device or performs input operations via the keyboard 20.

A pair of loudspeakers 24 are provided at the rear end of the cover 16. A plurality of operation button indicators 26 are provided between the loudspeakers.

The cover 16 has, at its rear end, a pair of hinge portions 28 spaced part in the widthwise direction of the case 14.

X The display unit 13 includes a display housing 30 and a liquid crystal panel 32 accommodated in the display housing 30. A window portion 31 for display is formed in the front wall of the display housing 30. The window portion 31 has almost the same size as the front wall. The display screen of the liquid crystal panel 32 is exposed outside the display housing 30 via the window portion 31.

The display housing 30 has a pair of concave connector portions 33 at one end. The concave connector portions 33 are spaced part in the widthwise direction of the display housing 30 and engaged with the pin portions 28 of the case 14. The display housing 30 is supported by hinges (not shown) provided on the concave connector portions 33 and the pin portions 28 to freely pivot with respect to the case 14.

Hence, the display unit 13 can pivot between a close position where the display unit falls and covers the upper surface of the case 14 including the palm rest 22 and the keyboard 20 and an open position where the display unit stands up to expose the upper surface of the case and the liquid crystal panel 32.

FIG. 1 shows the notebook computer 10 whose display unit 13 has pivoted to the open portion. In FIG. 1, the rod antenna 1 is detached from the pin jack 2.

As shown in FIG. 2, the rod antenna 1 has the pin plug 8 to be inserted in the pin jack 2 provided on the side surface 14b of the case 14. The rod antenna 1 also has an antenna main body 9 made of a flexibly bendable resin material. In this embodiment, the pin jack 2 is located near the palm rest 22. For this reason, the user's hand accidentally touches the antenna main body 9 at a high possibility. However, the flexibly bendable antenna main body 9 prevents the hand that has touched it from breaking the antenna main body 9 or the pin plug 8.

When the rod antenna 1 is attached to the device main body 12 by inserting the pin plug 8 in the pin jack 2 of the case 14, the long antenna main body 9 stands up from the side surface 14b of the device main body 12, as shown in the schematic view of FIG. 3. More specifically, the pin plug 8 and the antenna main body 9 have axes perpendicular to each other. The antenna main body 9 can pivot about the axis of the pin plug 8 (i.e. the axis of the pin jack 2). That is, the pin plug 8 functions as the rotating shaft of the rod antenna 1 in this embodiment. It is therefore possible to rotate the rod antenna 1 to a posture with a high reception sensitivity.

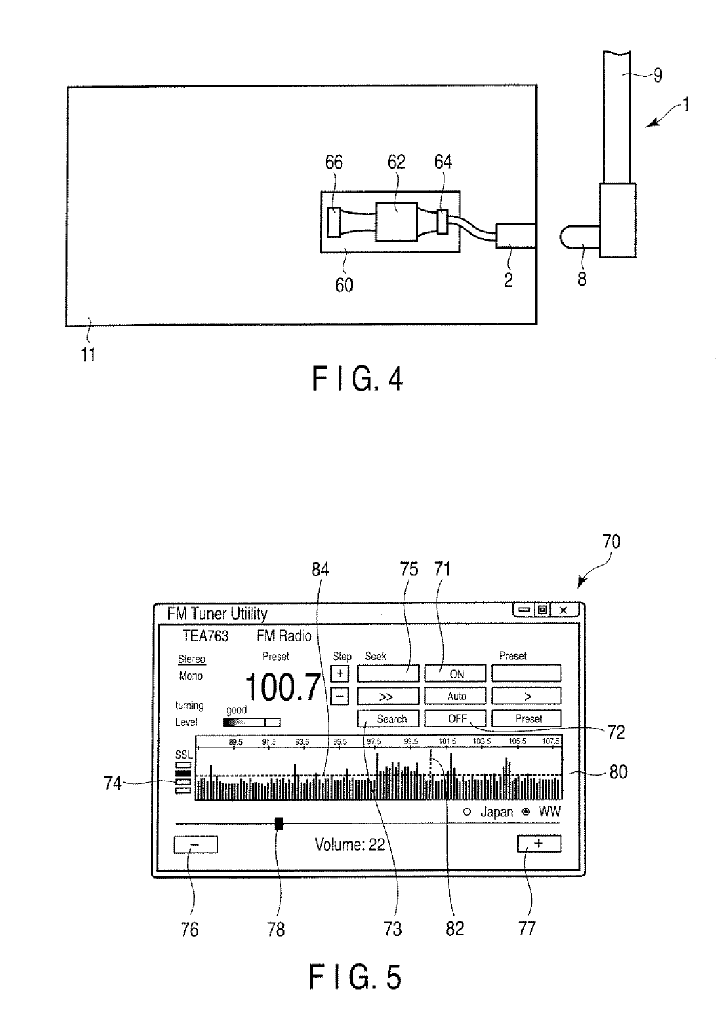

As shown in FIGS. 3 and 4, the case 14 of the device main body 12 incorporates a circuit board 11. The circuit board 11 is screwed to the bottom plate of the base 15 of the case 14. FIG. 3 is a schematic view showing a state in which the rod antenna 1 is attached to the notebook computer 10. FIG. 4 is a schematic plan view of the circuit board 11.

A child board 60 having an FM tuner module 62 is attached to the circuit board 11. A connector 64 for connecting the FM tuner module 62 to the pin jack 2 and a connector 66 on the signal output side of the FM tuner module 62 are attached to the child board 60. The child board 60 is detachable from the circuit board 11 in accordance with a user's request.

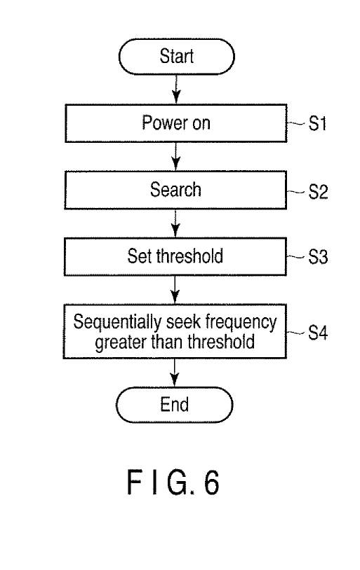

FIG. 5 shows an example 70 of an FM tuner operation window (to be simply referred to as the operation window 70 hereinafter) which displays the operation state of the FM tuner module 62 and various operation buttons of the FM tuner module 62. FIG. 6 is a flowchart for explaining a method of operating the FM tuner using the operation window 70. The FM tuner operation method will be described below with reference to FIGS. 5 and 6.

The operation window 70 shown in FIG. 5 is displayed via the liquid crystal panel 32 of the display unit 13. The operation window 70 displays a graph 80 that shows the reception levels of signals received via the rod antenna 1 for the respective frequencies. The operation window 70 also displays a power-on button 71, power-off button 72, search button 73, threshold setting buttons 74, seek button 75, volume down button 76, volume up button 77, and volume control button 78 in addition to the graph 80.

The graph 80 includes a vertical line 82 indicating the current listening target frequency, and a horizontal line 84 indicating the threshold of the signal level. The user can move the horizontal line 84 indicating the threshold up and down using the threshold setting buttons 74. More specifically, the settable threshold can be changed in four steps.

As shown in FIG. 6, when the power-on button 71 is pressed (step S1), and the search button 73 is pressed, signals receivable via the rod antenna 1 are scanned, and the levels of the received signals of the respective frequencies are displayed in the graph 80 (step S2). In this state, the user can rotate the rod antenna 1 to an optimum rotation position where the signal level is high. At this time, the signal level can be determined based on the graph 80.

After that, a desired signal level threshold is set (step S3). The user presses one of the four threshold setting buttons 74 to set a level threshold of his/her desire. The set threshold is indicated by the horizontal line 84 that moves on the graph 80.

For example, when the user lowers the threshold and presses the seek button 75, many frequencies having signal levels greater than the threshold are detected. When the user raises the threshold, the number of frequencies having signal levels greater than the threshold decreases. In this embodiment, one of the four thresholds is selected. However, the user may arbitrarily set the threshold.

When the user sets the threshold in step S3 and presses the seek button 75, signals having levels greater than the set threshold are sequentially sought (step S4). At this time, the vertical line 82 moves on the graph 80 from the left end to the right end in FIG. 5. For example, when the signal of the desired frequency is detected, the user presses the seek button 75 again to fix the frequency of the signal.

Sound of the FM tuner is output from the loudspeakers 24. The user can adjust the volume by pressing the volume down button 76 or volume up button 77 or by moving the volume control button 78 using a pointer (not shown).

As described above, according to this embodiment, the rod antenna 1 is detachable from the notebook computer 10. It is therefore possible to prevent the rod antenna 1 from being caught by an object and increase the portability in carrying the notebook computer 10.

Additionally, since the rod antenna 1 is detachable, it is unnecessary to arrange an antenna for FM reception in the case 14 of the device main body 12. Hence, no space for implementing an antenna is required in the case 14, and layout design becomes easy.

Furthermore, since the rod antenna 1 can be attached by inserting its pin plug 8 of the rod antenna 1 in the pin jack 2, the user can rotate the rod antenna 1 at its attachment portion and adjust the angle of the rod antenna 1. This allows to adjust the reception sensitivity of FM broadcasting in accordance with the installation location of the notebook computer 10.

While certain embodiments of the inventions have been described, these embodiments have been presented by way of example only, and are not intended to limit the scope of the inventions. Indeed, the novel methods and systems described herein may be embodied in a variety of other forms; furthermore various omissions, substitutions and changes in the form of the methods and systems described herein may be made without departing from the spirit of the inventions. The accompanying claims and their equivalents are intended to cover such forms or modifications as would fall within the scope and spirit of the inventions.

For example, the notebook computer 10 incorporating an FM tuner, as in this embodiment, may be connected to the Internet so that the title of music on the air in FM broadcasting is displayed, and the user can select the displayed title and purchase the music.

What is claimed is:

1. A notebook computer comprising:
a main body which incorporates a circuit board;
a display panel provided to open/close an upper surface side of the main body;
an FM tuner module mounted on the circuit board;
a pin jack which is provided on a side surface of the main body and connected to the FM tuner module; and
a rod antenna which is detachably attached to the pin jack outside the main body.

2. The computer of claim 1, wherein the pin Jack has a diameter larger than that of an earphone jack and a microphone jack which are provided on the side surface.

3. The computer of claim 2, wherein the rod antenna has a pin plug to be inserted in the pin jack.

4. The computer of claim 1, wherein the rod antenna has an antenna main body made of a flexibly bendable resin material.

5. The computer of claim 4, wherein the pin jack is provided on the side surface near a palm rest on an upper surface of the main body.

6. The computer of claim 1, wherein the display panel displays an FM tuner operation window which displays an operation state of the FM tuner module and various operation buttons of the FM tuner module.

7. The computer of claim 6, wherein the FM tuner operation window displays a graph which shows reception levels of frequencies of signals received via the rod antenna.

8. The computer of claim 7, wherein the FM tuner operation window displays a search button to scan signals receivable via the rod antenna and display the signals in the graph.

9. The computer of claim 8, wherein the FM tuner operation window displays a seek button to sequentially seek a signal greater than a preset threshold of the reception level.

10. The computer of claim 9, wherein the FM tuner operation window displays a threshold setting button to change the threshold.
